(19) United States
(12) Patent Application Publication
(10) Pub. No.: US 2013/0105704 A1
(43) Pub. Date: May 2, 2013

(54) White beam slit

(71) Applicants: Alex Deyhim, Ithaca, NY (US); Eric Van Every, Lansing, NY (US)

(72) Inventors: Alex Deyhim, Ithaca, NY (US); Eric Van Every, Lansing, NY (US)

(21) Appl. No.: 13/373,029

(22) Filed: Nov. 2, 2011

(51) Int. Cl. H01J 3/14

(52) U.S. Cl. 250/396 R; 356/239.4

(57) ABSTRACT

A white beam slit. The embodiment of this unit consists of vertical and horizontal slit mechanisms, a vacuum vessel which houses them, stepper motors, limit switches, electrical connections for a drain current measurement system and a stand for the vacuum chamber to attach to. For the base design, the fully scanable aperture can be up to 35 mm square with a maximum aperture of 50 mm square. For custom designs, the aperture can be significantly larger. A cooling assembly is incorporated within to maintain temperature of moveable slit components.

### CROSS REFERENCE TO RELATED APPLICATIONS

Not applicable

### STATEMENT REGARDING FEDERALLY SPONSORED RESEARCH OR DEVELOPMENT

Not applicable

### SEQUENCE LISTING OR PROGRAM

Not applicable

### BACKGROUND OF THE INVENTION

ADC has manufactured a number of white beam slit units for use in synchrotrons around the world including DLS, APS, BNL etc. These slits employ ADC's newly redesigned linear actuator providing highly accurate linear travels and are based on a standard DN150 cross. Each slit is customized to meet the needs of the client including aperture, heat load, resolution, accuracy, beam position monitoring, etc.

For the base design, the fully scan-able aperture can be up to 35 mm square with a maximum aperture of 50 mm square. For custom designs, the aperture can be significantly larger, though it requires moving actuators to adjacent flanges.

### SUMMARY OF THE INVENTION

This unit consists of vertical and horizontal slit mechanisms, a vacuum vessel which houses them, stepper motors, limit switches, electrical connections for a drain current measurement system and a stand for the vacuum chamber to attach to.

Each of the four blades is individually controlled and motorized. Each 45 mm wide blade can travel at least +20 mm (0.79″) in relation to the nominal beam axis resulting in a max aperture size of 40 mm×40 mm. In addition, each blade is offset so that it can travel −15 mm (0.59″ overlap) in relation to the nominal beam axis. The four blades are electrically conducting and insulated from the vacuum vessel. Each such blade is connected to a feed-through with a standard BNC connector. The vacuum vessel, a custom cylindrical chamber, contains ports for feed-throughs for drain current measurement on each of the blades.

The drive assembly uses stepper motor actuation and crossed-roller bearings. A linear encoder has been provided for positional feedback. Limit switches and hard stops prevent damage by over-travel. All UHV sections are vacuum tested to better than 10⁻⁸ mbar and have leak rate reports included in product documentation.

### BRIEF DESCRIPTION OF DRAWINGS

The invention as described herein with references to subsequent drawings, contains similar reference characters intended to designate like elements throughout the depictions and several views of the depictions. It is understood that in some cases, various aspects and views of the invention may be exaggerated or blown up (enlarged) in order to facilitate a common understanding of the invention and its associated parts.

FIG. 1 illustrates the overall white beam slit design.

FIG. 2 illustrates one of the actuators used in the white beam slit system.

FIG. 3 shows the actuator coupling assembly, removed from the vacuum chamber.

FIG. 4 illustrates the coupling.

FIG. 5 shows the blade holder and cooling path in a cross sectional view.

### DETAILED DESCRIPTION OF INVENTION

Provided herein is a detailed description of one embodiment of the invention. Therefore, specific details enclosed herein are not to be interpreted as limiting, but rather as a basis for the claims and as a representative basis for teaching one skilled in the art to employ the present invention in virtually any appropriately detailed system, structure, or manner.

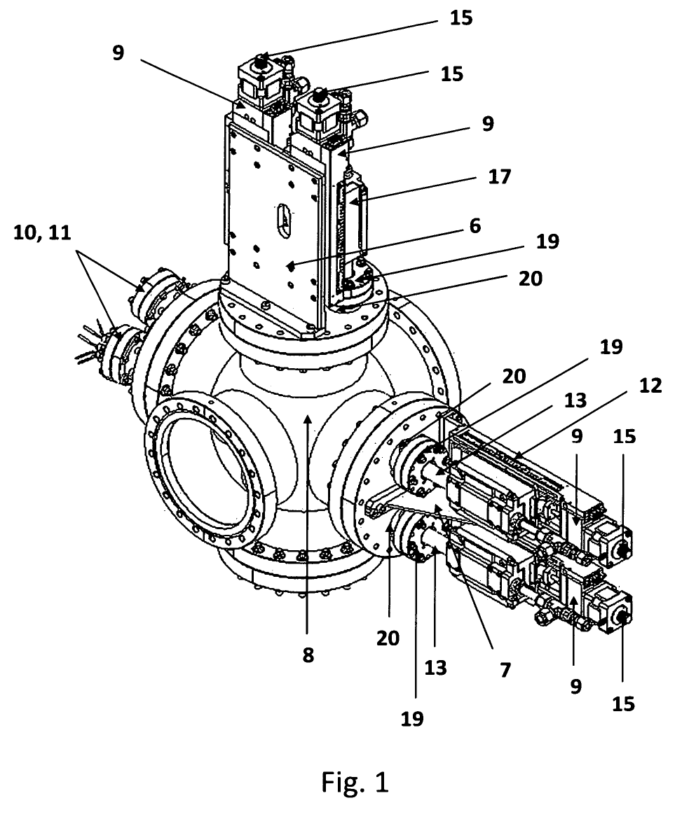

FIG. 1 shows the overall white beam slit unit. This unit consists of vertical 6 and horizontal 7 slit mechanisms, a vacuum vessel 8 which houses them, water cooling lines connected to the individual blades, stepper motors, limit switches and electrical connections for beam monitoring system. The vacuum vessel 8 contains ports 11 for an ion pump, roughing pump, fluorescent screen, cold cathode gauge, feed-throughs for drain current measurement, feed-throughs for temperature sensors and spare ports for future use. The electrical, vacuum and water connections are all housed on custom designed interface units, making attachment to the beamline simple and straight forward.

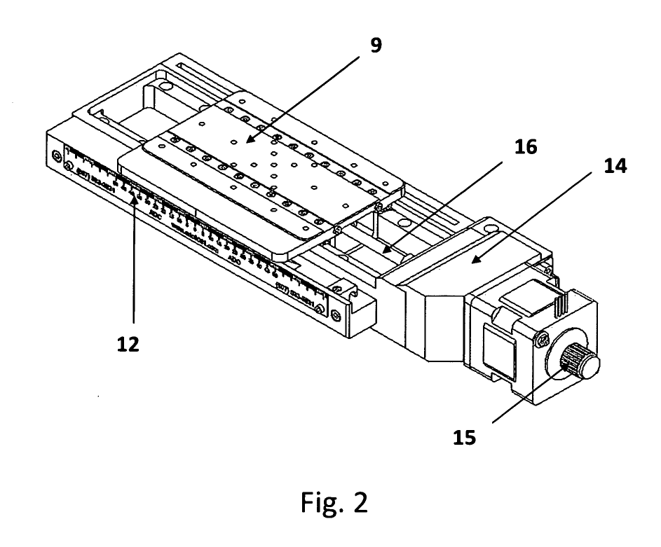

This slit employs ADC's newly redesigned linear actuators 9, providing highly accurate linear travel and are based on a chamber 8 with flanges 10 in beam direction. Each of the four blades are individually controlled and motorized. A spring-extended linear encoder with built-in home position is provided for each individual blade, and incorporated within the linear actuators 9, FIG. 2. The combination of linear encoder and linear actuator is referred to here as the translation system. The accuracy of the linear encoder is better than 1 micron. An easily visible linear scale 12 for each blade is attached to its translation system to provide an alternate way of reading blade position. Limit switches and hard stops, inside the translation system, prevent damage by over-travel. The four blades are electrically conductive and insulated from the vacuum vessel 8. Each blade is connected to a feed-through 13 with a standard connector. The drive assembly uses stepper motor 14 actuation and crossed-roller bearings, internally. A manual knob 15 allows sensitive touch-off zero confirmation in push mode applications.

The actuator provides an open loop positioning accuracy of 5 um per 25 mm and a closed loop positioning accuracy of up to 3 um per 1000 mm. Linear accuracy is assured by the highest precision crossed roller linear bearings with straightness of travel up to 2 um per 1000 mm of travel. The actuator employs a 400 step per revolution motor. Coupled with a 1 mm lead preloaded ball screw 16, provides a full step resolution of 2.5 um and a half step resolution of 1.25 um. The encoder within has a scale accuracy of +/−5 um per meter with a grating period of 20 um.

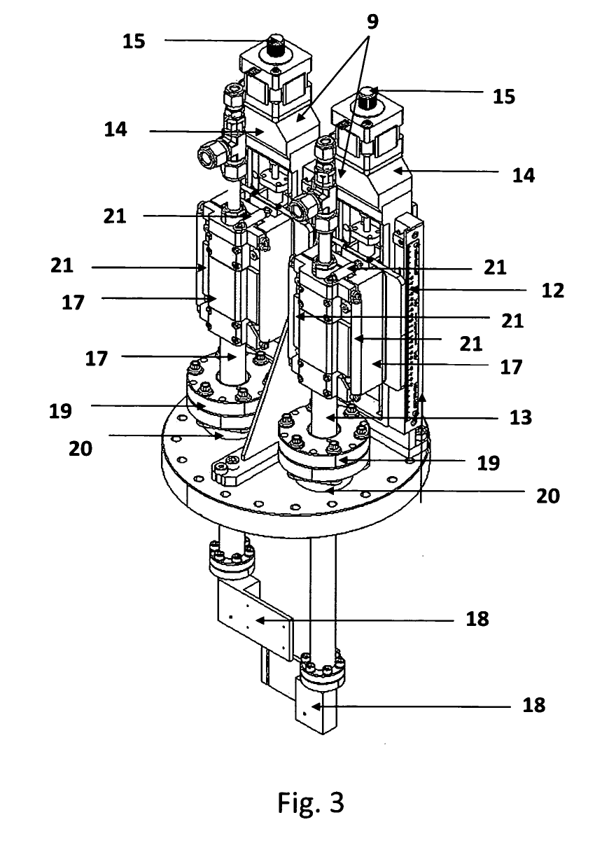

One key feature of the white beam slit is the ability to remove the actuators 9 in short time frame for bakeout with the ability to replace them in an equal amount of time within microns of the original position. The layout allows for easy vacuum system maintenance while preserving the accuracy of the system. FIG. 3 shows the assembly of the actuators 9 and coupling 17 between the linear feed-throughs 13 and blade holder mechanisms 18. Using a three-point mount, the actuator weldment 19 engages the main feed-through flange 20 in a kinematically determinate fashion, structure in which material compatibility can be used to calculate deflections, that provides quick removal and attachment. FIG. 3 shows the orientation in which the linear actuators 9 would be within the system. Details include previously mentioned stepper motor 14 and manual knob 15, as components of the translation system.

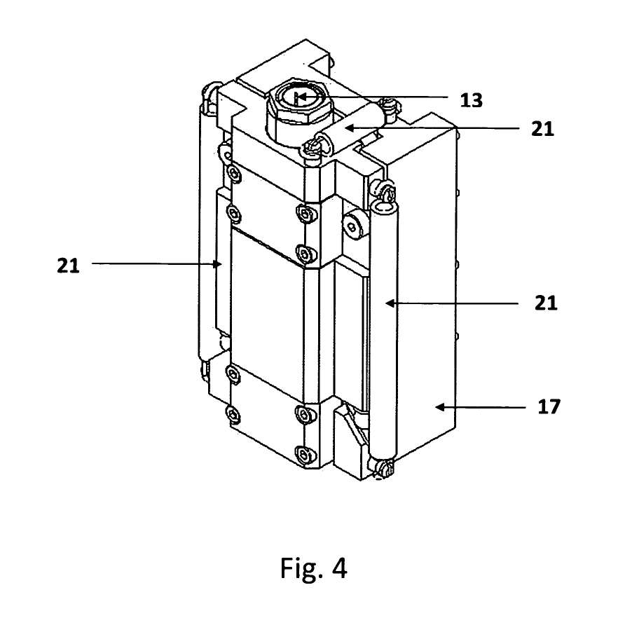

The actuator 9 is coupled to the linear feed-through shaft 13 using a three ball, three groove style coupling that has been optimized for the loading condition seen by the feed-through rod. FIG. 4 shows this coupling 17. The springs 21 shown are used to bind the coupling in place when used in a condition without vacuum preload. For example, during testing and shipping, the force generated from the vacuum preload will not exist and the springs function in this type of condition are to hold the joint of the coupling together.

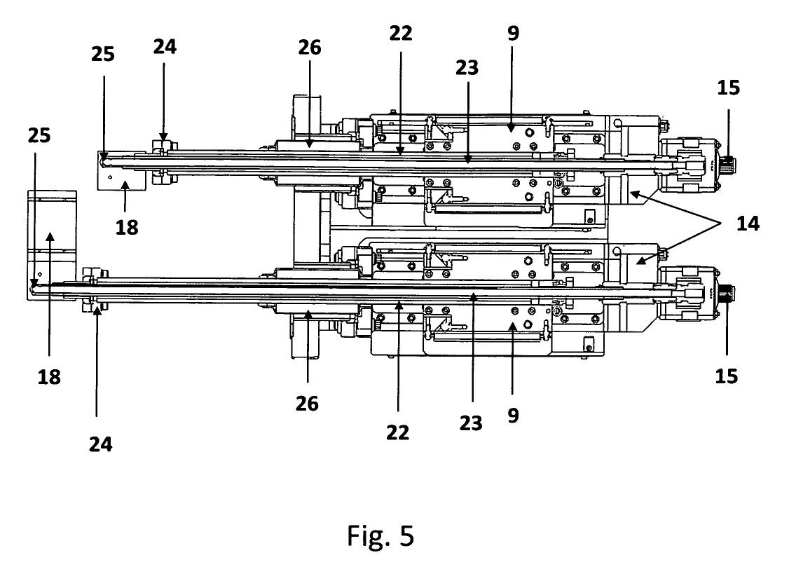

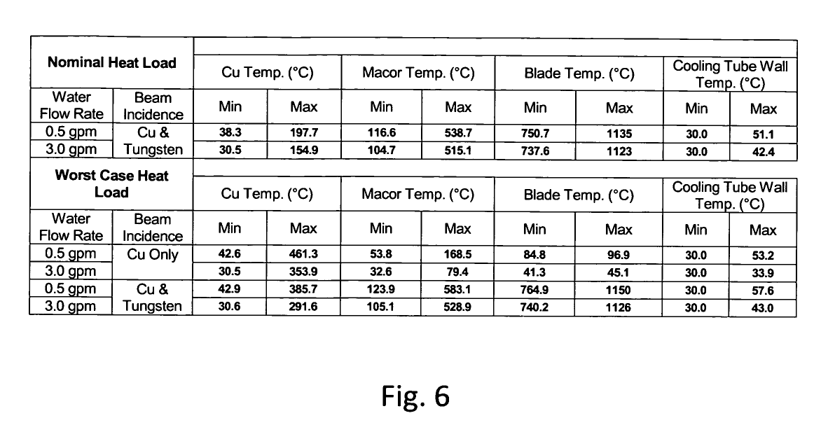

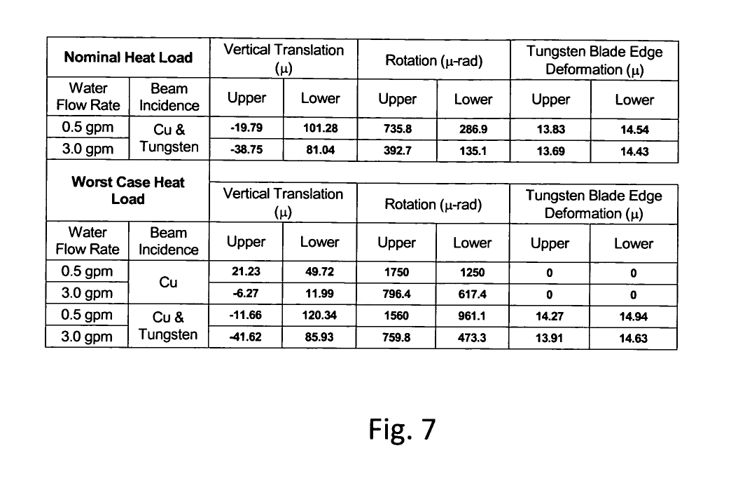

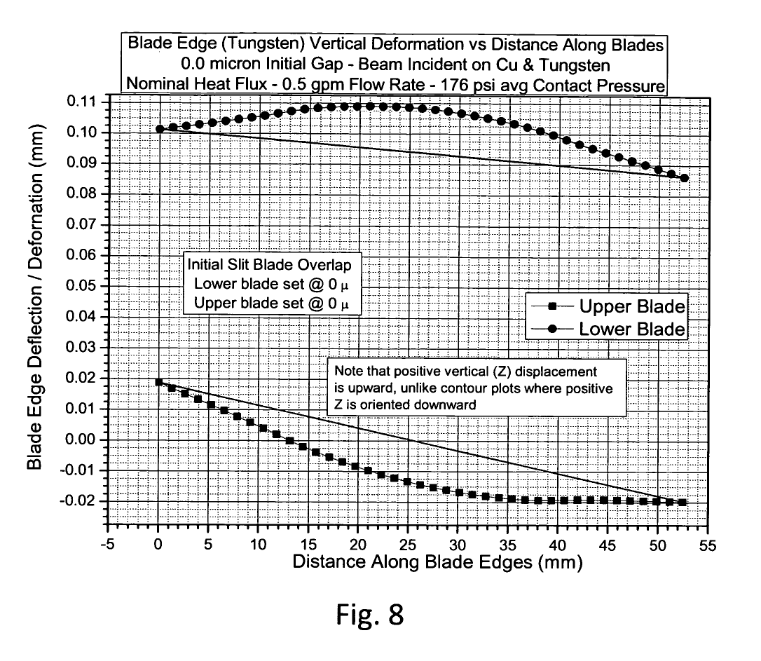

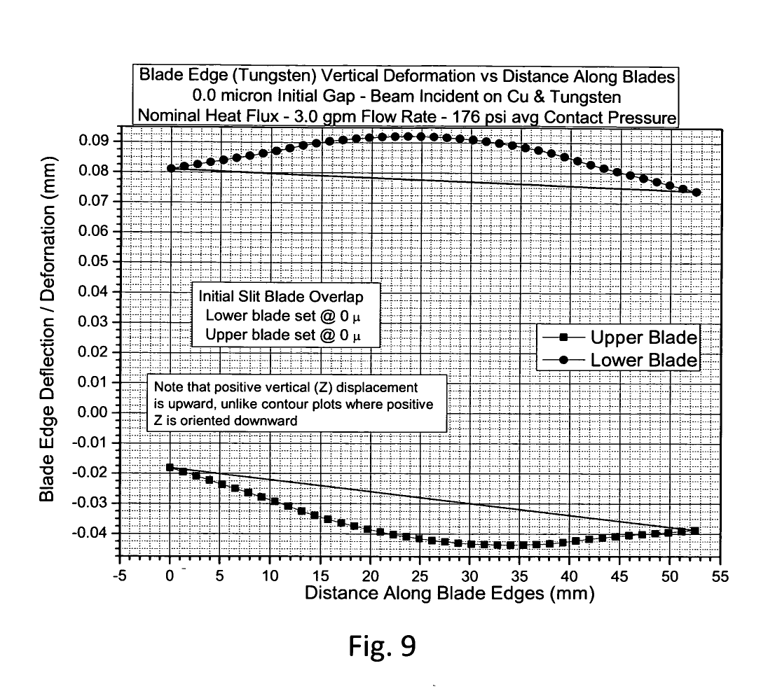

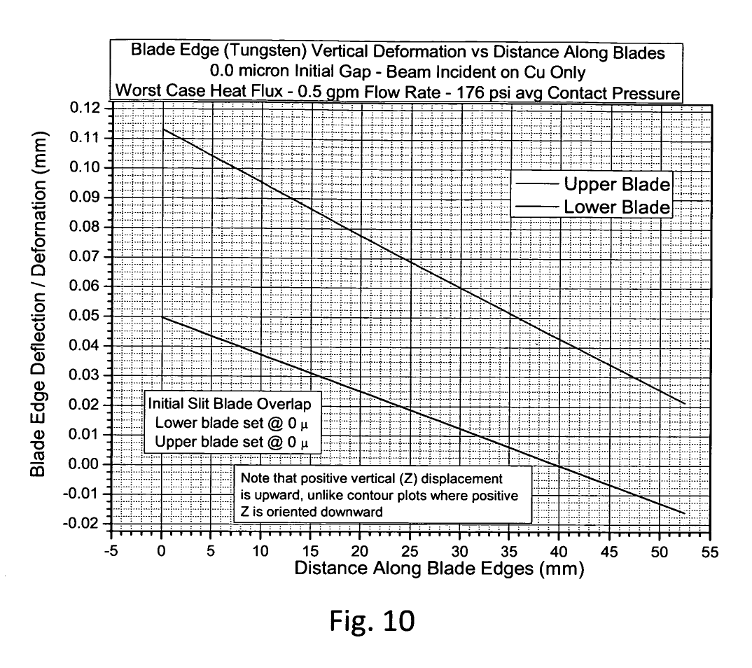

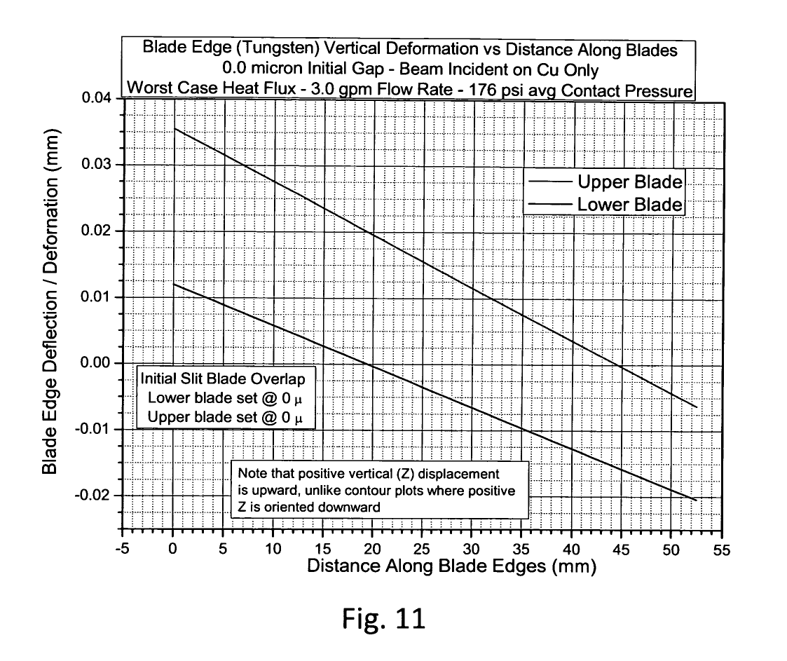

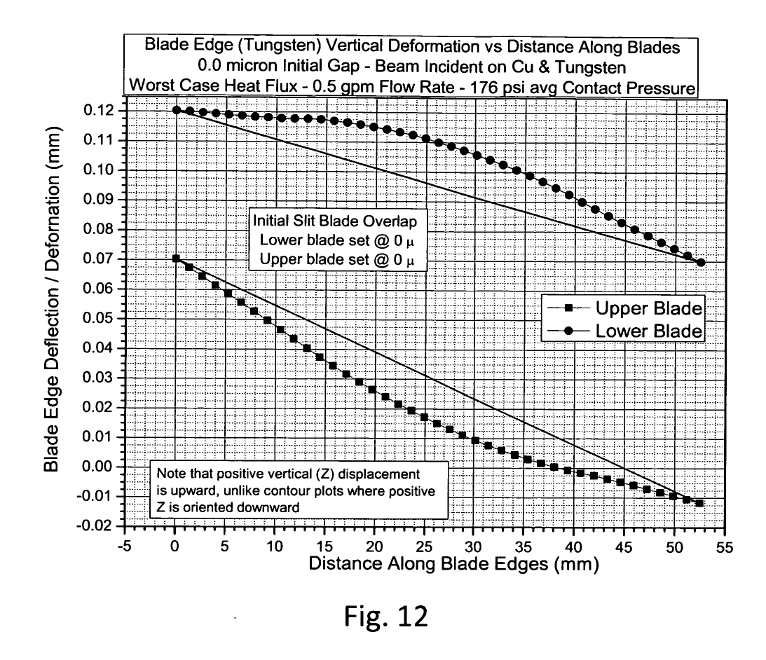

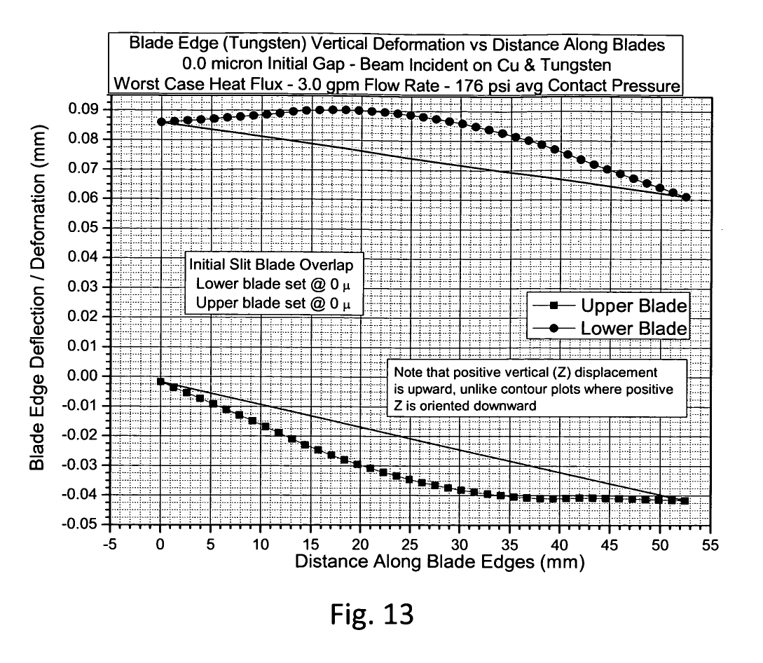

FIG. 5 shows a typical blade holder 18 as well as the cooling path (outer tube 22 and inner tube 23) and support structure in a cross sectional format. Water enters through the outer tube 22 and travels to the copper blade holder 18. The water then returns through the annular inner tube 23. A sustained flow rate will acceptably cool a heat load of up to 300 W per blade with minimal thermal strain in the supporting material. The structural tube (inner tube) 23 provides the vacuum guard for the system with a vacuum brazed joint 24 between the tube (outer tube) 22 and copper blade holder 18. The inner return tube 23 is floating inside the supply tube 22 and is fastened with a compression fitting 26. The blades are fastened to the blade holders 18 with aluminum nitride spacers 25. This allows for a very high thermal conductivity while allowing for insulation to ground. In this configuration, each blade can withstand up to 300 W of heating. For even more extreme cases, employing an indium foil between the blade and spacer 25, and spacer 25 and copper blade holder 18, can increase the thermal conductivity. The cross sectional view also illustrates linear actuator placement 9, location of manual knobs 15 and step motors 14.

In regards to beam monitoring, each blade is electrically isolated from ground using the aluminum nitride spacers, 25. A single wire is attached to each blade and fed through the vacuum chamber 8 with a floating shield BNC coaxial feed-through. This is used to determine the position of the beam. Four independent electrical connections are used. The minimum DC resistance between the blade and earth is >1010 ohms. Typically these are attached to a cluster flange on one of the remaining ports 11.

Each blade has two K type thermocouples to be able to monitor the temperature of both the blade holder and the blade. This data can be used to include compensation for thermal growth in the support structure and further increase the accuracy of the system. These are also typically attached to a cluster flange on an adjacent port, but in special cases the vacuum chamber is modified to add ports.

Blades are made from a machinable tungsten alloy, specifically 95% W, 2.5% Ni, 2.5% Cu. Each is wire EDM machined to shape followed by milling the surface relief and a preliminary grinding. After each blade is prepared, it undergoes a proprietary polishing process to give the highest quality knife-edge available in the synchrotron community.

ADC has performed a complete thermo-mechanical finite element analysis of this system for use in undulator beamlines with exceptionally high power density about a very small area of the aperture. It documents the resulting stresses and deflections due to thermal loading of the blades as well as verifies the adequacy of the cooling circuit.

Cooling of the slits is accomplished via conduction through the various components and interfaces of the assembly along with convection to the water running through the annular tubes within the stainless steel supports and cooling channels within the copper blade holding blocks. As this is a vacuum application, no external convection was assumed in the thermal simulations. The motor ends of the stainless steel support tubes were held constant @30° C. Radiation was also included in the thermal simulations in light of the relatively high power being evaluated. The pertinent parameters related to the cooling scheme are the thermal properties of the materials involved, the thermal contact resistance at various bolted interfaces, the convective heat transfer properties afforded by the water flow and the emissivity's of various surfaces. Emissivity was conservatively assumed to be 0.4 for all surfaces.

In order to calculate the convective heat transfer coefficient(s) associated with the water flow in the annular cooling tube and copper block flow channels, several flow conditions were evaluated so as to insure that the flow would be turbulent in order to maximize heat transfer (Incropera and DeWitt, Fundamentals of Heat and Mass Transfer, Wiley, N.Y., 1990). Note that for Reynolds numbers above˜3000,the following convection correlation for transition and turbulent flow is used (Petukhov and Hartnett, Advances in Heat Transfer, vol. 6, Academic Press, N.Y., 1970):

$${Nu}_{D} = \frac{( f \text{/} 8 ) ( {Re}_{D} - 1000 ) Pr}{1 + 12.7 {( f \text{/} 8 )}^{1 / 2} ( {Pr}^{2 / 3} - 1 )} \qquad [ 1 ]$$

where: f=(0.790 inRe_{D}−1.64)⁻². [2]

The convection coefficient is defined as

h=kNu_{D}/D_{H}. [3]

These correlations have been shown to be valid for 0.5<Pr<2000 and 3000<Re_{D}<5×10⁶.

ANSYS 8.1® was used for the steady state thermal and mechanical simulations presented herein. Approx. 150,000—quadratic tetrahedral, pyramid, and hexahedral elements were employed to model the water cooled slits assembly. Thermal contact resistance and mechanical contact at the bolted interfaces (tungsten blade/macor insulator and macor insulator/copper cooling block) were simulated with surface-to-surface contact elements. Calculations for thermal contact resistance were based on an average contact pressure of 176 psi due to tightening of the eight tantalum bolts to a torque of 0.18-0.22 Nm. This torque value is based on the yield strength of RO5200/RO5400 tantalum which is similar to a class 4.8 metric steel fastener. The tantalum bolts were represented by conduction link elements in the thermal analysis and 3D beam elements in the mechanical simulations. Constraint equations were utilized in connecting the beam elements to the solid elements of the tungsten blades and copper blocks

As this is a vacuum application, no free convection was specified for external surfaces. Radiation, however, was included resulting in a non-linear solution. Convective heat transfer coefficients were specified on the inner wall(s) of the annular cooling tube along with the cooling channels within the copper cooling blocks. In all simulations, the applied heat flux was 30 W/mm². Two thermal loading conditions were considered, nominal and worst case. Nominal conditions are assumed to be normal operating conditions, i.e., centered beam, 2100 W at 30 W/mm² divided evenly between the two blades assemblies. It is under these conditions that blade deformation is considered critical. Under worst case conditions, the assumption is that the beam (2100 W, 30 W/mm²) is incident on only one of the blade assemblies. The total power incident during the worst case simulations was actually 4200 W as each of the blade assemblies, which are essentially thermally independent with the exception of radiation, were subject to the full 2100 W. Further, worst case conditions were evaluated such that the beam was either incident on only the copper cooling block(s), or a combination of the (0.5 mm×28 mm) overlapped tungsten blade and (2.0 mm×28 mm) of the copper cooling block. Each loading condition was evaluated at two cooling water flow rates; 0.5 gpm and 3.0 gpm.

Once the thermal simulations were run, the resulting temperature distributions were applied as thermal loads to the mechanical version of the model. Full restraint was applied to each blade assembly at the “motor end” of the stainless steel support tube(s). The effect of bolt tightening was included in the first load step of each mechanical simulation. An initial strain corresponding to 70% of the proof load for a class 4.8 M2 fastener was applied to the 3D beam elements representing the tantalum bolts. The increase in bolt tension subsequent to application of thermal loads was typically only 5-10% of proof load.

FIG. 6 summarizes the thermal results of the various simulations. Temperature ranges observed in each part of the slit assembly are listed in FIG. 6 for both the upper and lower blade assemblies. The upper blade assembly invariably exhibits higher maximum temperatures than the lower blade assembly does due to the relative position of the annular cooling tube inlet with respect to the area of applied heat flux. The results in Table 1 indicate that as long as the flow is turbulent (<0.45 gpm, see attachment), the tungsten blade temperatures do not significantly vary (<25° C.) over the range of flow rates evaluated. This is primarily due to the conservative nature of the thermal contact conductance calculated for the various interfaces. As less and less of the tungsten blade is subject to incident radiation, i.e., lower tungsten overhang, the effectiveness of increased water flow rates increases while the detrimental effect of interfacial contact conductance decreases with respect to heat removal from the assembly.

FIG. 7 summarizes the mechanical results of the various simulations. FIGS. 8 through 13 show the displacements (Ux, Uy and Uz) of the slit assemblies along with a plot of the vertical (Uz) displacement/deformation along the opposing blade edges from left to right. Note however that positive vertical (Z) displacements listed in FIG. 6 and plotted in the graphs of FIGS. 8 through 13 are upward. As can be seen in FIG. 6, under nominal heat loading, overall translation of the opposing blade edges varies by about 20μ over a flow range of 0.5-3.0 gpm. Blade edge deformation is essentially unaffected by the evaluated cooling water flow rates.

The results presented in the “blade edge deformation vs distance along blade edge” plots in FIGS. 8 and 9 (nominal heat load cases) are based on initial opposing blade edge positions of 0μ and 0μ respectively for the lower and upper blades. The plots therefore show the final position/deformation of the blade edge(s) upon application of thermal loads. Typically the blade edges move up vertically (by unequal amounts) and the resulting blade overlap is more than the 0μ anticipated. The change in true position of the blade edges is a result of the thermal expansion of both the copper blocks, the stainless steel cooling/support tubes and the tungsten blades that are effectively expanding about the center of the tantalum bolt pattern. Therefore, for the lower blade assembly, the expansion of the copper, tungsten and stainless steel tend to be additive whereas for the upper blade assembly, the tungsten blade expansion is in effect subtracted from that of the copper and stainless steel.

The plots in FIGS. 10 through 13, which are included for reference purposes as they do not apply to normal operating conditions, are also based on initial opposing blade edge positions of 0μ and 0μ respectively for the lower and upper blades. These plots show the deformation(s) resulting from the worst case conditions where all 2100 W is incident on either the upper of lower blade assembly. Global bending stress within the Macor insulator(s) did not exceed 75 Mpa for any of the simulations and was typically lower than 50 MPa under nominal conditions. Flexural strength of the Macor is quoted to be 94 Mpa by Corning. Evaluation of localized stresses within the Macor insulator(s) in the vicinity of the tantalum bolts would require additional computational effort which was beyond the scope of the present analysis.

Results from the present thermal/mechanical simulations show that, for a nominal power density of 30 W/mm², applied evenly over an area of 70 mm² between upper and lower slit edges, the deformation of the upper and lower slit edges is typically less than 15μ. The slit edge deformation is essentially constant for water flow rates ranging from 0.5 gpm to 3.0 gpm. There is also a translation (−40-100μ) and rotation of the slit edges (135-736 μ-rad) that will affect the true position of, and anticipated gap between, the two opposing blade edges. This deviation from true position of the blade edges is due to the temperature distribution and subsequent thermal expansion within the copper blade mounts, tungsten blades and stainless steel cooling/support tubes resulting from the incident radiation. The overall blade edge translation varies less than 20μ over the range of cooling flow rates considered.

As previously implemented, the greatest contributor to this gap reduction and deviation from true position can potentially be controlled via strategic temperature measurement on the copper blade holders and/or stainless steel cooling/support tubes and subsequent compensation.

What is claimed is:

1. A white beam slit comprising:
(a) vertical and horizontal slit mechanisms;
(b) vacuum vessel;
(c) cooling assembly.

2. The apparatus of claim 1 wherein the vertical slit mechanism is a 90 degree, rotated copy of the horizontal slit mechanism.

3. The apparatus of claim 1 wherein the slit mechanism is comprised of
(d) two linear actuators;
(e) two linear encoders;
(f) a coupling assembly;
(g) blades.

4. The apparatus of claim 3 wherein each linear actuator independently controls one of four blades within the slit mechanism.

5. The apparatus of claim 3 wherein each linear actuator is controlled using a 400 step per revolution stepper motor with manual knob for push mode applications.

6. The apparatus of claim 3 wherein linear accuracy is assured by the highest precision crossed roller linear bearings.

7. The apparatus of claim 3 wherein linear encoders are used in order to translate blade position within 1 micron.

8. The apparatus of claim 3 wherein linear encoders have a built in home position for each associated blade.

9. The apparatus of claim 3 wherein linear encoders contain limit switches and hard stops in order to prevent damage caused by over-travel.

10. The apparatus of claim 3 wherein actuators are coupled together, using a coupling.

11. The apparatus of claim 10 wherein the coupling is attached to each actuator and further attached to the vacuum vessel of claim 1.

12. The apparatus of claim 10 wherein coupling is done for stability and ease of removability during bakeout and replacement to original position within microns.

13. The apparatus of claim 1 wherein said vacuum vessel is made of stainless steel.

14. The apparatus of claim 1 wherein said vacuum vessel contains additional ports, separate from those which hold actuator couplings, in order to create space for an ion pump, roughing pump, fluorescent screen, cold cathode gauge, feed-throughs for drain current measurement, feed-throughs for temperature sensors and spare ports for future use.

15. The apparatus of claim 1 wherein said cooling assembly comprises:
(h) an outer supply tube;
(i) an inner return tube;
(j) vacuum brazed joint;
(k) aluminum nitride spacers.

16. The apparatus of claim 15 wherein said inner tube serves as the structural tube and provides the vacuum guard for the system.

17. The apparatus of claim 15 wherein said aluminum nitride spacers allow for very high thermal conductivity while allowing for insulation to ground.

18. The apparatus of claim 3 wherein said blades are made from a machinable tungsten alloy, specifically 95% W, 2.5% Ni, 2.5% Cu.

19. The apparatus of claim 3 wherein each said blade has two K type thermocouples to be able to monitor the temperature of both the blade holder and the blade.

20. The apparatus of claim 3 wherein after each said blade is shaped it undergoes a proprietary polishing process to give the highest quality knife-edge.
